(19) United States
(12) Patent Application Publication
(10) Pub. No.: US 2012/0185640 A1
(43) Pub. Date: Jul. 19, 2012

(54) CONTROLLER AND METHOD FOR CONTROLLING MEMORY AND MEMORY SYSTEM

(75) Inventors: Kuo-Hsiang Hung, Hsinchu (TW); Jian-Kao Chen, Hsinchu (TW)

(73) Assignee: MStar Semiconductor, Inc., Hsinchu (TW)

(21) Appl. No.: 13/241,798

(22) Filed: Sep. 23, 2011

(30) Foreign Application Priority Data
Jan. 19, 2011 (TW) 100101994

(51) Int. Cl. G06F 12/02

(52) U.S. Cl. 711/103; 711/E12.008

(57) ABSTRACT

A memory controller for multiple addressing modes is provided. The memory controller includes a transmitting unit and a control unit. The transmitting unit transmits an identification message to a non-volatile memory. According to whether the non-volatile memory feeds back an acknowledgement message in response to the identification message, the control unit determines an addressing mode to be used for communicating with the non-volatile memory.

### FIELD OF THE INVENTION

The present invention relates to a memory, and more particularly to a memory controller and a method for controlling a memory.

### BACKGROUND OF THE INVENTION

Many electronic devices implements a read-only memory for storing set values or reference data needed for operation. An electrically-erasable programmable read-only memory (EEPROM), being one kind of read-only memory, offers advantages of being durable and low in cost as well as having a simple writing procedure, and is thus extensively applied in various electronic devices.

Depending on memory capacities, different addressing modes are adopted for the memories to communicate with external control circuits (e.g., a timing controller). The higher the capacity of a memory is, the greater the number of bit count of addresses for storing locations in the memory gets. Taking a current serial EEPROM as an example, EEPROMs of 4K/8K/16K bits (Kb) capacities adopt one-byte addressing mode to communicate with an external control circuit; whereas EEPROMS of 32 Kb/64 Kb/128Kb/256 Kb/512 Kb capacities adopt two-byte addressing mode to communicate with an external circuit.

FIG. 1A shows a timing diagram of data being written to an EEPROM having an internal inter-integrated circuit (I²C) interface by an external control circuit using one-byte addressing. The timing corresponds to information carried by a data line in the I²C interface. As shown in FIG. 1A, after sending a device address of the EEPROM and receiving an acknowledgement (ACK) signal from the EEPROM, the external circuit continues to transmit a 1-byte word address to the EEPROM to indicate an address of a storage unit in which the written data is stored. Upon again receiving an ACK signal from the EEPROM, the external control circuit then sends out data to be written into the EEPROM.

FIG. 1B shows a timing diagram when two-byte addressing is adopted. As shown, between “device address” and “written data”, the external control circuit uses a 2-byte word address to indicate an address of a storage unit in which the written data is stored.

FIG. 2 shows a schematic diagram of an example of a serial EEPROM, which implements an I²C interface including a data pin 5 and a clock pin 6. Pins 4, 7 and 8 are respectively ground GND, write protection WP and power VCC. Pins 1, 2 and 3 are addressing pins A0 to A2 that connect to one same transmitting port of the EEPROM. Current 1 Kb/2 Kb/4 Kb/8 Kb/16 Kb/32 Kb/64 Kb/128 Kb/256 Kb/512 Kb serial EEPROMs generally have a pin configuration as shown in FIG. 2.

Under a situation that the control circuit connects to only one EEPROM, addressing pins A0 to A2 of the EEPROM are kept floating. Supposing one control circuit is connected to a several EEPROMs, the addressing pins A0 to A2 of each of the EEPROMs are connected differently. FIG. 3 shows an example of a memory control circuit 12 simultaneously connected to four 1 KbEEPROMs 10A to 10D. As shown, the pins A1 and A0 of the four EEPROMS 10A to 10D are respectively fixed to 00, 01, 10 and 11, where 0 represents a low voltage level and 1 represents a high voltage level. The floating pin A2 is regarded as being connected to a low voltage level.

FIG. 4A shows a “device address” format when an external control circuit communicates with a 1 Kb/2 KbEEPROM. By filling columns A0 to A2 with different contents, the memory control circuit 12 in FIG. 3 calls a predetermined EEPROM among the EEPROMs 10A to 10D. For example, out of the “device address” sent out by the memory control circuit 12, columns A0 to a2 are filled by 010, but only the EEPROM 10C feeds back an ACK signal.

Although 4 Kb/8 Kb/16 KbEEPROMs adopt one-byte addressing, the one-byte word address is in fact insufficient for indicate all storage space in the memory. Therefore, in practice, during communication between an external control circuit and 4 Kb/8 Kb/16 KbEEPROMs, partial columns of the “device address” are used to indicate partial memory internal addresses. More specifically, for the 4 Kb/8 Kb/16 KbEEPROMs, information in the “device address” may contain part of the word address information.

FIGS. 4B to 4D are respectively “device address” formats when an external control circuit communicates with 4 Kb/8 Kb/16 Kb EEPROMs. Referring to FIG. 4B, for the 4 Kb EEPROM, the original AO column is replaced by P0. The 4 Kb EEPROM has two memory pages. P0 is a part of the word address information for distinguishing between the two memory pages. When the column P0 is filled by 1, it means that the external control circuit is calling for the second memory of the EEPROM.

Referring to FIG. 4C, for an 8 Kb EEPROM, the original A0 and A1 columns are replaced by P1 and P0, which are a part of the word address information for distinguishing four memory pages in the 8 Kb EEPROM. As shown in FIG. 4D, for a 16 KbEEPROM, the original A2, A1 and A0 columns are replaced by P2, P1 and P0, which are a part of the word address information for distinguishing between eight memory pages in the 16 Kb EEPROM. Because the columns A0 to A2 are completely replaced, the 16 Kb EEPROM is not able to share the control circuit with other EEPROMs of the same capacity in FIG. 3.

Further, for an EEPROM that adopts two-byte addressing, the external control circuit does not utilize the “device address” for filling word address information when communicating with an EEPROM of large capacity since two bytes are already sufficient for representing the word address. FIG. 4A also shows a “device address” format when an external control circuit communicates with a 32 Kb/64 Kb/128 Kb/256 Kb/512 Kb EEPROM.

It is apparent from the above description that, a hardware designer should select an external control circuit depending on the capacity of a memory in order to allow valid communication between the external control circuit and the memory. In the prior art, to accommodate memories that use different addressing modes, a control circuit manufacture is required to manufacture and prepare inventory of at least two different kinds of control chips, meaning that complications caused at production lines and inventory management are inevitable.

Therefore there is a need for a control chip solution that is capable of solving the above complications caused at production lines and inventory management.

### SUMMARY OF THE INVENTION

The present invention provides a memory controller and a method for controlling a memory that support at least two different addressing modes, and are capable of determining which of the addressing modes is appropriate according to an actual communication with the memory. Through the solution provided by the invention, a control circuit manufacturer is required to manufacture and prepare inventory of only one kind of control chip, certain pins of which need not be fixedly connected either as in the prior art, so that complications caused at production lines and inventory management are minimized.

The present invention provides a memory controller comprising a transmitting unit and a control unit. The transmitting unit transmits a predetermined identification message to a non-volatile memory operating with the memory controller. According to whether the non-volatile memory feeds back an acknowledgement message in response to the predetermined identification message, the control unit determines an addressing mode to be used for communicating with the non-volatile memory.

The present invention further provides a method for controlling a memory. The method comprises steps of transmitting a predetermined identification message to a non-volatile memory, and determining an addressing mode to be used for communicating with the non-volatile memory according to whether the non-volatile memory feeds back an acknowledgement message in response to the predetermined identification message.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1A and 1B are timing diagrams of information carried by data lines between an external control circuit and an EEPROM.

FIG. 2 is a schematic diagram showing an external of an EEPROM.

FIG. 3 is a memory controller simultaneously connected to a several EEPROMs.

FIGS. 4A to 4D are device address formats of communications between a control circuit and EEPROMs of various capacities.

FIG. 5 is a block diagram of a control circuit according to an embodiment of the invention.

FIG. 6 is a flowchart of a method for controlling a memory according to an embodiment of the invention.

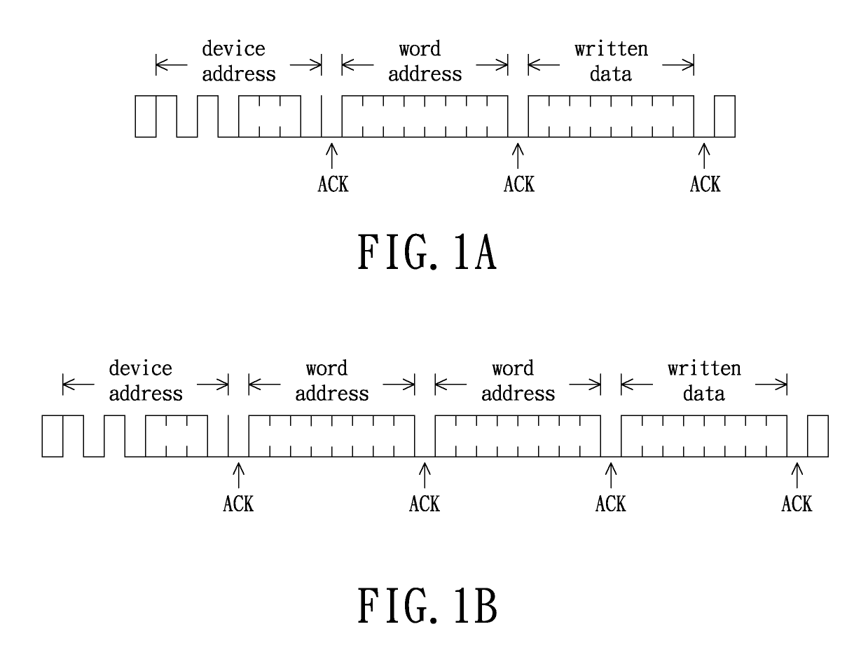

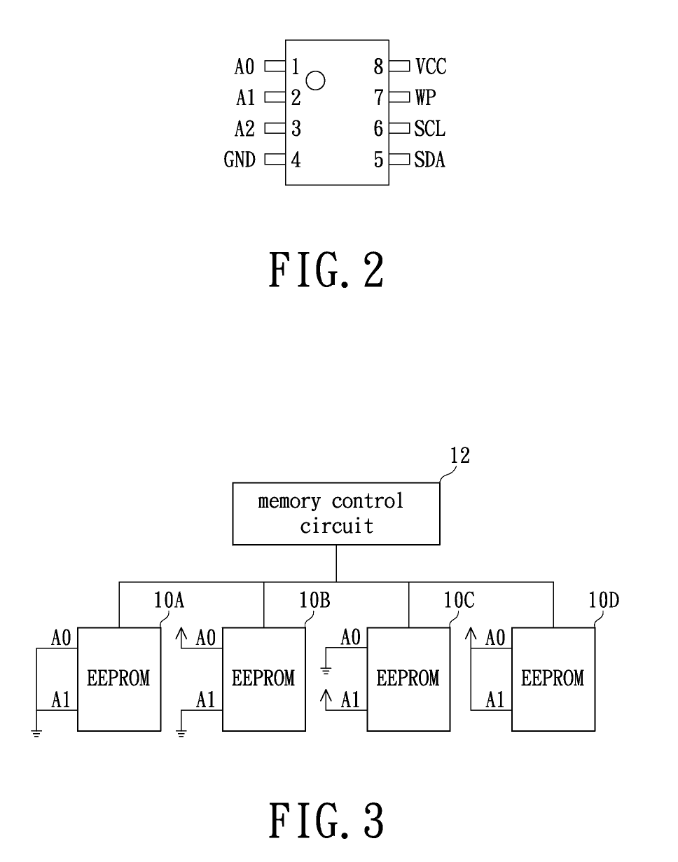

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

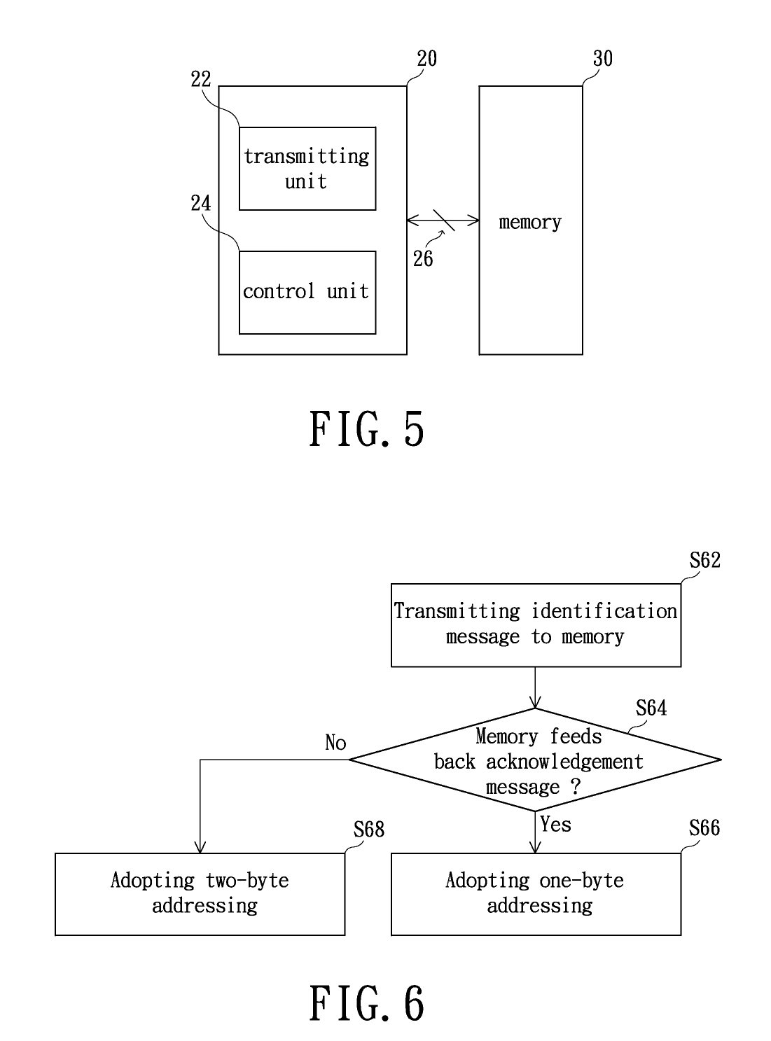

FIG. 5 shows a block diagram of a memory controller 20 according to an embodiment of the invention. In this embodiment, a non-volatile memory 30 is an EEPROM, and communicates with the memory controller 20 though an I²C interface 26. In actual circuit applications, the memory controller 20 and the memory 30 can be implemented in various electronic devices requiring memories.

The memory controller 20 supports at least two types of addressing modes. Before the memory 30 is initialized, the memory controller 20 is unaware of the capacity of the memory 30 and is thus incapable of determining an appropriate addressing mode for communicating with the memory 30. As shown in FIG. 5, the memory controller 20 comprises a transmitting unit 22 and a control unit 24. Once the memory 30 is powered on and initialized, the transmitting unit 22 transmits a predetermined identification message to the memory 30. In this embodiment, the predetermined identification message is a device address.

When a device address of the memory 30 matches the device address provided by the transmitting unit 22, the memory replies to such call to feed back an acknowledgement message. The control unit 24 then determines an addressing mode to be used for communicating with the memory 30 according to whether the memory 30 feeds back the acknowledgement message in response to the predetermined identification message. For example, the predetermined identification message and the acknowledgement message can be transmitted via a data line between the two circuits.

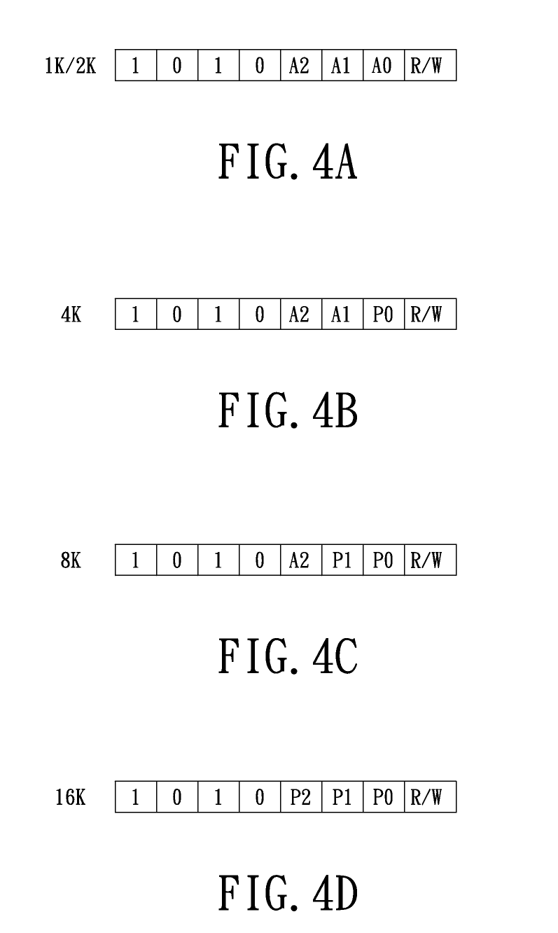

In this embodiment, assume that the capacity of the memory is 4 Kb/8 Kb/16 Kb/32 Kb/64 Kb/128 Kb/256 Kb/512 Kb, and the memory controller 20 is connected to only one memory. When the memory controller 20 communicates with the 4 Kb/8 Kb/16 Kb EEPROM, part of the columns of the “device address” are used for representing partial memory internal addresses. The “device address” format suitable for EEPROMs of the above three capacities are respectively illustrated in FIGS. 4B to 4D. The “device address” format suitable for 32 Kb/64 Kb/128 Kb/256 Kb/512 Kb EEPROMs are as shown in FIG. 4A.

According to the “device address” formats shown in FIGS. 4A to 4D, several regularities below are concluded. Supposing the predetermined identification message transmitted by the transmitting unit is 10100000. All kinds of EEPROMs, such as 32 Kb/64 Kb/128 Kb/256 Kb/512 Kb EEPROMs, all feedback an acknowledgement message. Supposing the predetermined identification message transmitted by the transmitting unit 22 is 10100010, it means that the memory controller 20 is calling a second memory page of the memory 30. As a result, only 4 Kb/8 Kb/16 Kb EEPROMs comprising at least two memory pages feed back an acknowledgement message. More specifically, 32 Kb/64 Kb/128 Kb/256 Kb/512 Kb EEPROMs do not feed back an acknowledge message when receiving the predetermined identification message 10100010.

Further, supposing the predetermined identification message transmitted by the transmitting unit 22 is 10100100, it means that the memory controller 20 is calling a third memory page of the memory 30; thus, only 8 Kb/16 Kb EEPROMs comprising at least three memory pages feed back an acknowledgement message. Supposing the predetermined identification message transmitted by the transmitting unit 22 is 10101000, it means that the memory controller 20 is calling a fifth memory page of the memory 30, such that only 16 Kb EEPROMs comprising at least five memory pages feed back an acknowledgement message.

In this embodiment, after the transmitting unit 22 transmits the predetermined identification message of 10100010, memories that feed back an acknowledgement message are 4 Kb/8 Kb/16 Kb EEPROMs, whereas memories that do not feed back any acknowledgement message are EEPROMs of other capacities. Therefore, upon receiving the acknowledgement message from the memory 30, the control unit 24 determines the capacity of the memory 30 as 4 Kb/8 Kb/16 Kb, and adopts one-byte addressing to communicate with the memory 30. Conversely, supposing no acknowledgement message is fed back from the memory 30, the control unit 24 determines the capacity of the memory 30 is higher than 16 Kb, and thus adopts two-byte addressing to communicate with the memory 30.

With the disclosure of the above embodiment, it is clear that with application of the present invention, fixed pins of a selected addressing mode for a control circuit is no more needed; it also frees a manufacturer of the memory controller 20 from managing and keeping inventory of different types of chips. More specifically, memories of different capacities are allowed to share one single control circuit, so that a control circuit manufacturer can greatly reduce complications at production lines and inventory preparations.

It is to be noted that addressing modes are not limited to the abovementioned one-byte addressing and two-byte addressing, and the types of memories are not to be limited to the EEPROM of the above embodiment. By identifying regularities of addressing modes, as well as applying the concept of determining an appropriate addressing mode through transmitting a predetermined identification message and detecting whether the memory feeds back an acknowledgement message by a memory controller, the present invention is applicable to many other memories.

FIG. 6 shows a flowchart of a method for controlling a memory according to an embodiment of the present invention. In Step S62, a predetermined identification message is transmitted to a memory. In Step S64, it is detected whether the memory feeds back an acknowledgement message in response to the predetermined identification message. When a result from Step S64 is affirmative, Step S66 is performed to determine one-byte addressing is to be used for communicating with the memory. When the result from Step S64 is negative, Step S68 is performed to determine two-byte addressing as the addressing mode when communicating with the memory.

Operations of FIG. 6 are performed by the memory controller 20 and the memory 30 in FIG. 5, and shall not be further described for brevity.

Therefore, the memory controller and method for controlling a memory according to the present invention are designed to support at least two addressing modes and then determine which addressing mode is to be used according to a communication result with the memory. By implementing the present invention, a controller chip manufacturer only needs to manufacture and prepare inventory of one type of control chip, and valuable pins of a chip shall not be occupied by fixed pin connections as in the prior art, so that complications at production lines and inventory management are minimized. Further, the concept of the present invention is applicable to memories of different capacities and thus different addressing modes.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A memory controller, comprising:
a transmitting unit, for transmitting a predetermined identification message to a non-volatile memory; and
a control unit, for determining an addressing mode for communication with the non-volatile memory according to whether the non-volatile memory feeds back an acknowledgement message in response to the predetermined identification message.

2. The memory controller according to claim 1, wherein the transmitting unit transits the predetermined identification message to the non-volatile memory after the non-volatile memory is initialized.

3. The memory controller according to claim 1, wherein the identification message is a device address.

4. The memory controller according to claim 1, wherein the control unit determines a capacity of the non-volatile memory as 4 Kb, 8 Kb or 16 Kb and adopts one-byte addressing mode to communicate with the non-volatile memory when the non-volatile memory feeds back the acknowledgement message.

5. The memory controller according to claim 1, wherein the control unit determines a capacity of the non-volatile memory is higher than 16 Kb and adopts two-byte addressing mode to communicate with the non-volatile memory when the non-volatile memory does not feedback the acknowledgement message.

6. The memory controller according to claim 1, wherein the predetermined identification message and the acknowledgement message are transmitted through an inter-integrated circuit (I²C) interface.

7. The memory controller according to claim 1, wherein the predetermined identification message is 10100010 represented in binary.

8. The memory controller according to claim 1, wherein the non-volatile memory is an electrically-erasable programmable read-only memory (EEPROM).

9. A method for controlling a non-volatile memory, comprising steps of:
transmitting a predetermined identification message to the non-volatile memory; and
determining an addressing mode for communication with the non-volatile memory according to whether the non-volatile memory feeds back an acknowledgement message in response to the predetermined identification message.

10. The method according to claim 9, wherein the addressing mode is determined as one-byte addressing when the non-volatile memory feeds back the acknowledgement message.

11. The method according to claim 9, wherein the addressing mode is determined as two-byte addressing when the non-volatile memory does not feed back the acknowledgement message.

12. The method according to claim 9, wherein the predetermined identification message and the acknowledgement message are transmitted through an I²C interface.

13. The method according to claim 9, wherein the identification message is a device address.

14. The method according to claim 9, wherein the predetermined identification message is 10100010 represented in binary.

15. A memory system, comprising:
a non-volatile memory; and
a memory controller, for transmitting a predetermined identification message to the non-volatile memory, and determining an addressing mode for communication with the non-volatile memory according to whether the non-volatile memory feeds back an acknowledgement message in response to the predetermined identification message.

16. The memory system according to claim 15, wherein the transmitting unit transits the predetermined identification message to the non-volatile memory after the non-volatile memory is initialized.

17. The memory system according to claim 15, wherein the identification message is a device address.

18. The memory system according to claim 15, wherein the memory controller adopts one-byte addressing mode to communicate with the non-volatile memory when the non-volatile memory feeds back the acknowledgement message, and adopts two-byte addressing mode to communicate with the non-volatile memory when the non-volatile memory does not feed back the acknowledgement message.

19. The memory system according to claim 15, further comprising:
an inter-integrated circuit (1²C) interface, through which the predetermined identification message and the acknowledgement message are transmitted.

20. The memory system according to claim 15, wherein the predetermined identification message is 10100010 represented in binary.
